(19) United States
(12) Patent Application Publication
(10) Pub. No.: US 2015/0267796 A1
(43) Pub. Date: Sep. 24, 2015

(54) Auto Meds

(71) Applicant: June Pierce Wilson, JR., Vale, OR (US)

(72) Inventor: June Pierce Wilson, JR., Vale, OR (US)

(21) Appl. No.: 14/222,974

(22) Filed: Mar. 24, 2014

(51) Int. Cl. F16H 47/02; B60K 17/10

(52) U.S. Cl. CPC F16H 47/02; B60K 17/10

(57) ABSTRACT

Auto Meds technology replaces the work to the transmissions that engine does

Hydraulic pressure replaces the static pressure of torque from engine to the transmission

Velocity of flow replaces the RPM of engine to the transmission giving us non-fueled energy to the drive axles taking away 90% of the work engines do.

Eliminating the acceleration of engine and run to a perfect air fuel mixture of 14.7 to 1 100% of the time on existing manufactured products on the road leads to total non-fueled energy when we stop producing the engine.

This is made to be adapted to everything on the road today existing and new builds with engines. Doesn't matter how old, how big, or how heavy, Auto Meds will motivate them.

The results of this:
Reduces the use of fuel by 80-90%
Reduces the cost of living in fuel savings
Eliminates 99.5% of exhaust gases to the atmosphere of 1 acceleration up to speed
Gives us more power better performance than the engine ever will

Copyrights 1-124336720 Auto Meds© technology reduces 99% of gas emissions.

### SPECIFICATIONS

Resistance to the load is the same on static energy or dynamic force.

Resistance to static energy requires more energy to the load than dynamic force.

Engines are static energy to the load of vehicles.

Transmissions are where the load on all vehicles begins on the input shaft.

The clutch on a standard transmission (SIT) is the engagement connection to the engine.

Torque Converter is the engagement connection from engine to automatic transmission (A/T).

Both the Torque converter and clutch have to engage the transmission statically to avoid engine stall.

Clutch has to slip with slow engagement and high RPM to start the load.

Torque converter converts torque to pressure by spinning fluid against an impeller in converter with high RPM to start the load rolling.

Gears in S/T allow a higher gear ratio in the differential because of more gearing in transmission.

A/T requires a lower gear ratio in differential than S/T.

Gears and gear ratios are the only way the static energy of engine can move anything by lowering the resistance to the motion.

### Tests:

The maximum torque of the engine is the pressure measurement to transmission from engine.

Resistance measured in pounds per square inch (PSI), at the input shaft, current application

Class 10 truck with Detroit diesel D60 requires 960 pound feet of torque to the input shaft of the transmission @ 1100 RPM to start a GVW 70,000 lb. load rolling and full throttle to 2200 RPM to first shift A/T will require the same torque.

Duplicating the same pressure to transmission at the input shaft with torque wrench using dynamic pressure requires 500 foot lbs of force to start the same load rolling.

At the moment of movement on drive wheels resistance starts to drop and continues rolling with less force less resistance.

Formula for PSI=Diameter×PI×Length of shaft (D×PI×L)

Input shaft measurement D 1.125″×3.1416×L 7″=24.74 square inches

960/24.74=38.80 PSI from engine to start load rolling

500/24.74=20.21 PSI dynamic force starts load rolling

Duplicating static pressure of 38.80 PSI with dynamic pressure of 20.21 PSI takes less 18.59 PSI.

Standard Transmission: (S/T) 13 speed Road ranger (same truck as mentioned above).

100 PSI @ 10 gal per minute hydraulic pump (rating of hydraulic pump required)

12V or 24V electric motor @ 500 RPM power source to pump connected to reservoir.

All fluid line (¾″) to transmission control valves in bell housing.

Control valves FIG. 3A pg 5-5 attached to impeller gear FIG. 1C pg 3-5 housing on gear assembly.

Gear assembly on input FIG. 1a pg 1-5 and FIG. 4a pg 4-5 (Conversion Gears) shaft running transmission in place of removed/eliminated torque converter/clutch (removes the engine from the load).

Outlet line ¾″ and wire harness exit side of sealed bell housing.

Outlet lines on A/T (2 impellers) join together inside bell housing before bypass valve line.

Outlet line connects to suction flow pump energized by 12v motor.

On existing vehicles on the road outlet line returns to reservoir giving non-fueled drive to the drive axles.

On new builds outlet flow goes to another impeller driver connected to front shaft
(Front shaft to belt pulley that runs power steering alternator Heat pump air conditioner etc. that was run by engine to be as manufactures want for their product) Only for new car manufacturing built without an engine.

Outlet comes out of suction flow then returns to reservoir.

12v or 24v power source energizes pressure pump.

Fluid flowing at 10 gallon per minute to control valves (FIG. 3a) controls flow to and from impeller gear (FIG. 1c) in place of removed clutch assembly disconnects engine from transmission and replaces engine acceleration and accelerates the rotation of input shaft at a velocity of 10 oz. per second builds enough pressure to run anything an engine runs. Fluid runs through impeller gear out and to suction flow FIG. 3A pg 5-5 pulls the fluid pressure from impeller and transmission as fluid flows it builds pressure and slows at resistance suction flow pushes out with enough pressure from velocity to run second impeller on new build giving non fueled transportation on existing products.

Gears in the transmission turn the output shaft (drive line) faster than rotation of input shaft.

Differential gears (ring and pinion) turn the axles to wheels faster than drive line (gear ratio).

End result gives us non-fueled motion to drive axles.

Results are non-fueled power and energy to drive axles 80-90% less fuel usage and tested on existing manufactured products 99.5% less emissions from exhaust of 1 engine acceleration up to speed.

Produces more power and performance than engines currently provide.

Control valves, pressure flow pump, suction flow pump, are operated by electronic module integrated into present modules automotive modules to engine and transmission using the foot pedals as we do now.

### FEDERALLY SPONSORED RESEARCH OR DEVELOPMENT

Not applicable

### BACKGROUND OF INVENTION

Sciences of earth, physics, automotive, and hydraulics

References:
50 years experience and knowledge of automotive theories
Repair manuals, engine theory
Laws of Physics to motion dynamic and static energy
Hydraulics' correlation to gear ratios in vehicles

Problems With Transportation:
Effects of engine use to society, humanity, and nature
Carbon oxide exhaust gases saturating atmosphere of earth
Inability of engines to burn any kind of fuel without lethal gas emissions

This technology Auto Meds© (Copyrights title) replaces the work engines do changing the static energy of the engine to drive our cars to dynamic force to drive all.

### SUMMARY OF THE INVENTION

This innovation Auto Meds© removes the use of the engine as the power source to the input shaft of the transmission by eliminating the clutch assembly on S/T and torque converter on A/T disconnects the engine from the transmission where work begins

Replacing the static energy of torque with hydraulic fluid pressure to do the work engines do

The velocity of hydraulic fluid replaces the RPM of engine to the input shaft of the transmissions

Gear assemblies and impeller drivers, does the work of removed torque converter (A/T) to the input shaft and clutch assembly (S/T)

Supplying external fluid force of hydraulic pressure and flow, thus providing a non-fueled power source to drive axle on existing manufactured with an engine and promotes non-fueled transportation on new manufacturing reducing exhaust emissions to the atmosphere.

This is designed to be installed and used on everything that uses an engine regardless of age, size, weight, or what it is the engine runs eliminating the engines for our future.

Auto Meds© Registration Number TXu 1-915-884 Feb. 24, 2014

### DESCRIPTION OF DRAWINGS

Drawings are of the manufactured mechanical items needed to convert transmissions length of shaft and transmissions are different in all makes and models and have to be made specific to each vehicle.

Replacement Sheet Page 1-5

FIG. 1A Conversion gear for A/T does the work of removed torque converter.

Machined gears (1) (2) (3) and (4) form one gear assembly when pressed together.

Gear (1) is machined separately with input shaft gear in center and fluid flow assist reduces pressure of transmission line pressure.

Gear (1) attaches to outer gear (2) with a fluid tight weld.

Gears (2) and (3) have bearing seats machined in center and inner seat matching the bore of entire gear assembly promoting independent operation of each gear.

Gear (3) machined on the inner end to transmission specifications establishing gear (4) into transmission.

Inner bore of entire gear assembly matches the inner bore of removed torque converter gear and is fluid tight to 250 PSI line pressure from transmission.

Machined gears on outer diameter of Gears (2) and (3) are drive gears for the impeller gears.

Outer diameter of Gear 4 machined to transmission specifications.

Outer diameter of gear 3 machined splines spline depth larger than machined splines on Gear (2).

Outer diameter of gear 2 machined splines spline depth smaller than gear 3.

Replacement Sheet Page 2-5

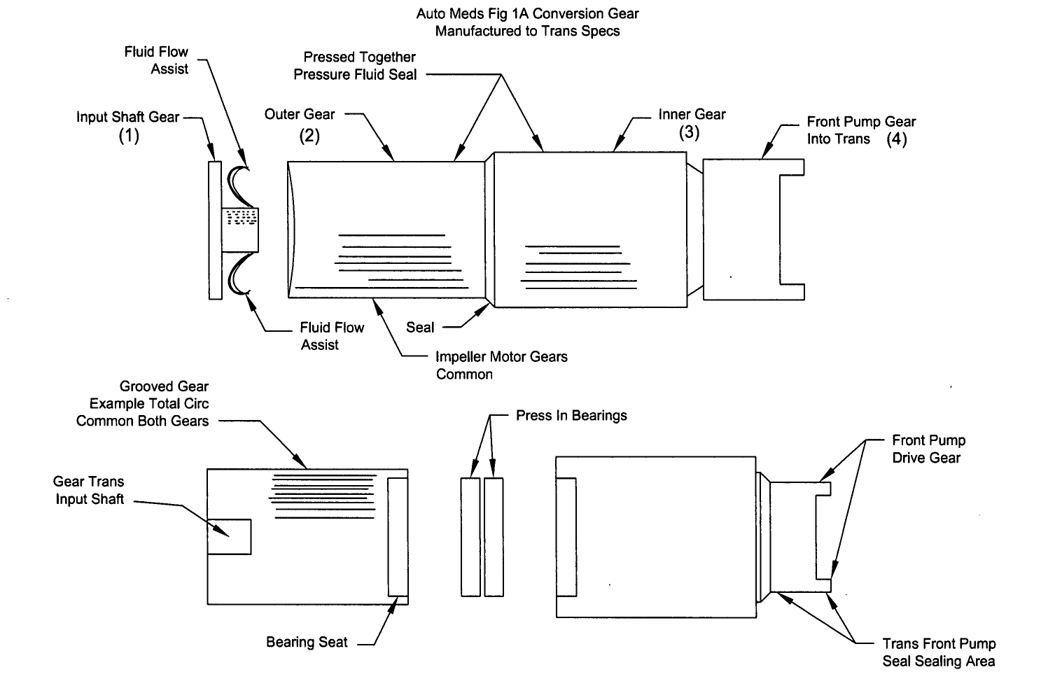

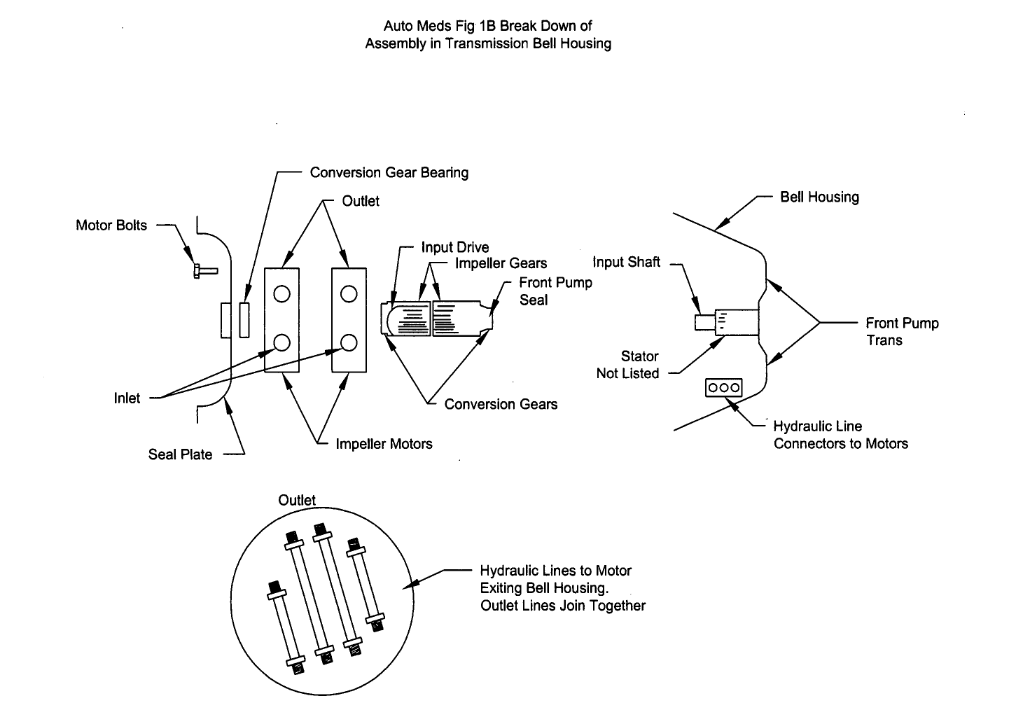

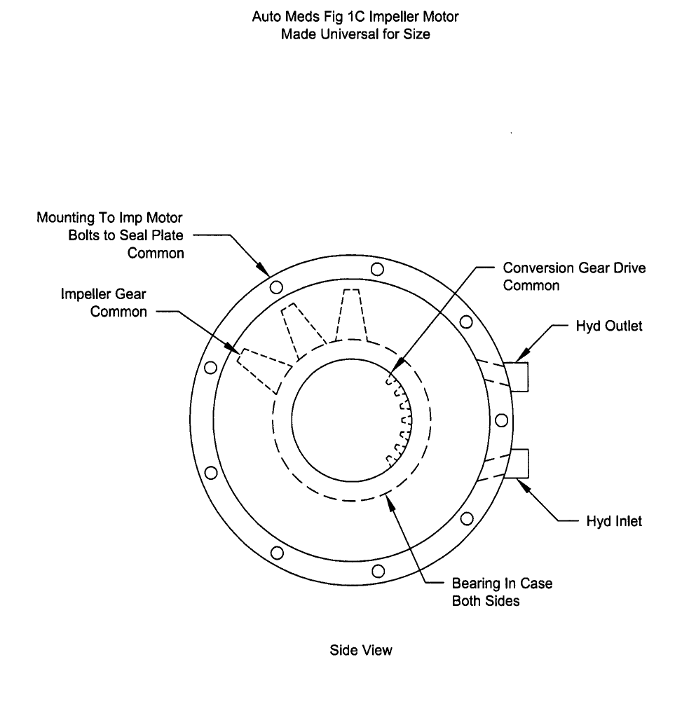

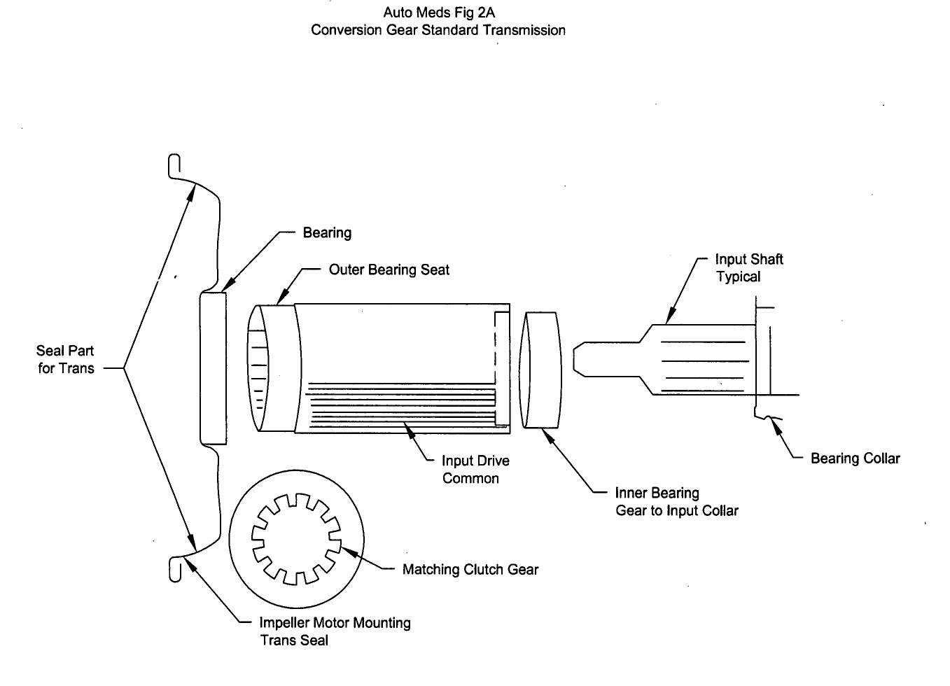

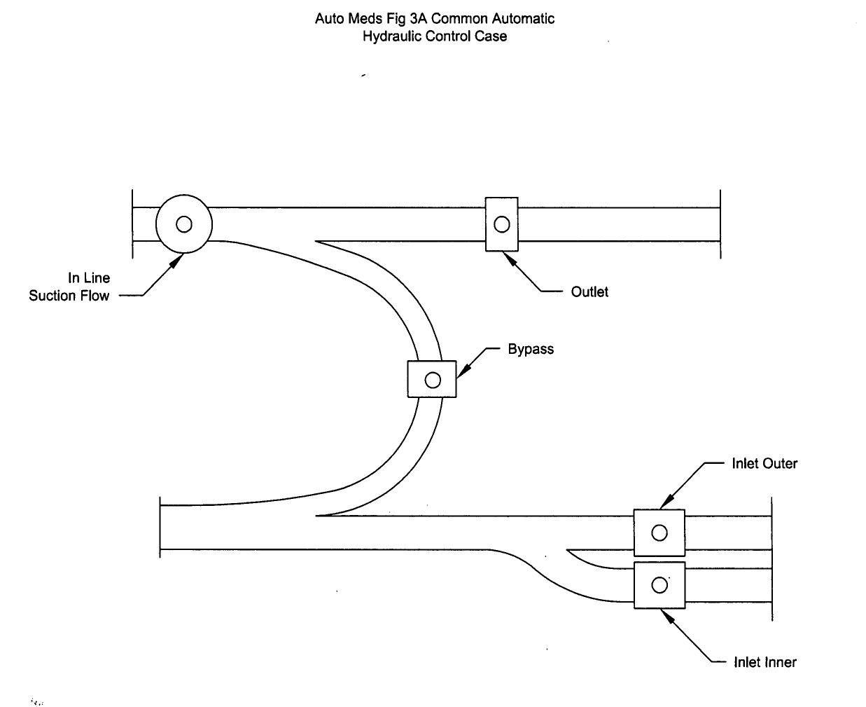

FIG. 1B Gear assembly install first to A/T transmission (right side), to build in bell housing.

FIG. 1A conversion gear installs first

Two each inner and outer Impeller gears of FIG. 1C., over 1A.

Seal plate (left side), made of rigid steel, non-flexible to 250 PSI for A/T stabilizing conversion gear, bolting impeller gear solid to plate and keeping pressure transmission.

Bolts to bell housing with mounting bolts from transmission to engine with ¼″ clearance between transmission and engine.

S/T installs the same as A/T using different conversion gear configuration as shown in FIG. 2A, using one impeller gear as shown in FIG. 1C.

Replacement Sheet Page 3-5

FIG. 1C Machined inner gear, bearings on both sides, sealed to the last 1″ of impeller housing with machined gears on the inner diameter of impeller in housing.

Impeller gear inside of housing as an assembly drives Conversion Gears with fluid force to impeller, powers input shaft and transmission (A/T) 2 ea. (S/T) 1 ea.

A/T overall diameter from transmission connection is approximately 6″.

Inner Diameter of impeller gear inside of housing is the same as outer conversion gear.

Replacement Sheet Page 4-5

FIG. 2A Conversion gear does the work to transmission as in place of clutch

Conversion Gear for S/T is a machined gear with inner bearing seat on inner side.

Outer end of conversion gear machined to fit clutch gear on inside diameter of conversion gear.

Clutch gear is a machined gear matching the removed clutch gear to input shaft.

Outer diameter machined for impeller gear FIG. 1C. 3-5

Outer end of gear machined on outside diameter for bearing inside of seal plate.

Inner bearing in seal plate provides non-resistance and no flex motion to conversion gear.

Inner bore (cylindrical steel 1¾″ with 2″ outer diameter) same as A/T conversion gears

Machined grooves on outer diameter of conversion gear matching Impeller gear of A/T

Seal Plate (left side) made of ridged steel, centers the input shaft attaches between engine and transmission at transmission mounting bolts giving ¼″ more clearance for flywheel when reinstalled.

Replacement Sheet Page 5-5

FIG. 3A Hydraulic control system mounts on impeller gears inside bell housing.

Suction Flow (top left of drawing) is on return line outside of transmission.

A/T has two inlet valves, one to the inner impeller gear and one to outer impeller gear, FIG. 1B.

By-pass valve bridges between inlet and outlet lines.

Outlet valve on outer impeller gear on outlet port of gear regulates and assists with braking of vehicle.

Outlet on inner impeller gear connects to outlet line inside transmission on hydraulic manifold.

### DETAILED DESCRIPTION OF INVENTION

A/T Pre-manufactured cars trucks on the road and new builds manufactured with engines

Adaption Kits will have all parts and instructions for installation for make and model specific

Technicians Remove the transmission and discard the converter.

Install the Conversion Gear into transmission front pump Gear (4) FIG. 1A aligning with front pump and input shaft gear (1) at the same time.

Cut out port on bell housing for seal for fluid lines and harness exiting bell housing.

Install the inside FIG. 1C page 3-5 impeller gear onto gear (3)

Install the outer FIG. 1C Page 3-5 Impeller gear onto gear (2)

Mount Hydraulic control manifold into inlet and outlet ports lines exiting thru bell housing port.

Connect control valves and wire harnesses to Control Valves and sensors route out through port.

Bolt balanced weight onto the flywheel where the removed torque converter mounted

Install the seal plate and bolt Impeller gears against front pump housing seat with outer Conversion Gear Bearing in seal plate.

Reinstall the transmission with seal plate bolting between engine and transmission adding ¼″ clearance between engine and transmission

Insert seal for the cut out over inlet outlet and Harness

Mount the reservoir and Hydraulic pressure flow Pump

Install module and Switches to Accelerator Pedal and Brake Pedals

Connect hydraulic inlet lines to inlet on transmission and pressure flow pump and secure lines.

Connect Outlet line to transmission outlet and to suction flow pump from suction flow to return to reservoir.

Install wire harness to module, Pumps, Control Valves, accelerator pedal, and brake pedal

Turn on power to electrical system to pressurize system.

Suction flow then pulls from the reservoir and maintains the flow.

System is ready to go. Raise on lift put into neutral inlet valve to transmission opens fluid to

Impeller turning the front pump and transmission pressurizes internally.

Shift into gear inlet valve opens fills input impeller gear gets air out and then it can be road tested when system is full they will remain full with no air in impeller gears.

S/T is the same as above with the exception of the transmission conversion gear, FIG. 2A Page 3-5, one impeller gear, and clutch switch.

### How Auto Meds Works

Turn on key (Start the engine on products with engine) power to electric motor energizes pressure flow pump pressurizes to suction flow pump

Suction flow pump accelerates fluid flow to replacing RPM of engine

Module monitors pressure to impeller gears (motors) for control with control valves.

Inlet outer opens and closes from foot pedal signals more or less fluid flow

Bypass opens giving neutral affect fluid stops flowing to impeller gear on demand

Outlet valve slows flow for slow down and stop

A/T step on brake pull into gear Transmission internal pressurizes outer impeller gear pressurizes transmission operates automatically according to pressures as normal

Accelerator pedal increases flow as pedal is pushed down decreases flow as accelerator is let off

Brake pedal pressurizes impeller to allow brake assist same as engine braking

Clutch on SIT depressed opens bypass giving neutral effect for shifting

Let up bypass closes increasing flow to impeller gear step on accelerator flow increases

Let up accelerator transmission slows the vehicle

Module signals operator for shift points up or down shift according to pressures

1. Auto Meds takes the work engines do running the power source to the transmission input shaft thru the gear train to the drive axles, leaving the engine on pre built to run the front of the engine on all sizes shapes, age, and weight of vehicles, increasing power and performance making the engine obsolete.

1. The innovation described in this Application disconnects the engine from the load. Eliminates engine acceleration and gives us non-fueled energy to the drive axles on existing manufactured products. Promotes the production non-fueled energy too our transportation on new manufacturing.

2. Greenhouse gas saturations levels, announced this year by the World Health Organization, is reaching total saturation of air molecules killing life on earth, is 99% from the burning of any kind of fuel in engines, the man made gases are lethal that man nor money cannot get rid of, causing ecocide to the environment. Auto Meds stops the addition to these gases, and will give nature a chance to get rid of them

2. Environmental
Eliminates gas emissions on each car installed on by 99.5% of one acceleration up to speed
Reduce gas emissions by zillions of metric tons of daily submissions from all vehicles existing and new with engines.
This ends the threat of total saturation to our atmosphere from exhaust emissions.
Once earth recycles these gases gets rid of our climate changing gases.
This will end the Global warming restoring world health for the future of humanity.

3. Auto Meds gives back everything oil and gas has taken away from society, spending for a depleting resource is causing insolvency in the world transportation is needed for everything causing inflation of products causing recessions, for shipping lowering profits ending corporations, jobs and creating homelessness, deficits in nations and states for infrastructures, that no amount of money will cure, ending the need for oil except for manufactured products petroleum is needed for, will cure every economy in the world and create an industrial revolution for the 21st century and beyond ending the pending fuel crisis of running out of fuel.

3. Economy
Eliminating engine acceleration on manufactured products with engine uses 80-90% less fuel
This lowers the cost of living to every person that owns a vehicle.
Reduce the costs of shipping for businesses that uses transportation.
Stops need of foreign oil spending ends the deficit spending.
Restores our economy in the US with a gross national product everyone in the world will have
